(19) United States
(12) Patent Application Publication
(10) Pub. No.: US 2003/0070886 A1
(43) Pub. Date: Apr. 17, 2003

(54) Wheel hub with stiffened flange

(75) Inventor: Robert W. Hacker, Canton, OH (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: The Timken Company

(21) Appl. No.: 09/981,539

(22) Filed: Oct. 17, 2001

(51) Int. Cl. B60T 1/06

(52) U.S. Cl. 188/18 R

(57) ABSTRACT

A hub assembly for coupling a road wheel and a brake rotor to the suspension system of an automotive vehicle includes a hub which rotates relative to a suspension system member on a bearing. The hub includes a spindle which extends into the bearing and a flange which is formed integral with the spindle. The flange has a front face that perpendicular to the axis and a back face that is slightly oblique to the axis as well as circumferential rib at its periphery. The back face is interrupted by lands, and here threaded studs extend through the flange and beyond the front face. Lug nuts, which are threaded over the studs, secure the rotor and the wheel to the flange. The circumferential flange reduces distortion of the front face of the flange under the forces exerted by the studs and also under inertial forces transferred to the road wheel.

### CROSS REFERENCE TO RELATED APPLICATIONS

None

### STATEMENT REGARDING FEDERALLY SPONSORED RESEARCH OR DEVELOPMENT

None

### BACKGROUND OF THE INVENTION

This invention relates in general to hub assemblies for automotive vehicles and more particularly, to a hub assembly, the hub of which has a stiffened flange.

Many automotive vehicles of current manufacture have their road wheels coupled to their suspensions systems through hub assemblies which are supplied as package units ready for installation during the assembly of such vehicles. The typical hub assembly basically includes a housing of some type which is attached to a component of the suspension system for a vehicle, a hub to which the road wheel and also a brake rotor is secured, and a bearing between the hub and the housing to enable the hub to rotate relative to the housing with minimal friction. The bearing must accommodate thrust as well as radial loads and is preferably set to a condition of preload, so that the bearing operates without internal clearance, and the axis of rotation, as a consequence, remains stable. The typical hub has a spindle which extends into the bearing and a flange which projects radially from the spindle in front of the bearing and the housing which contains the bearing. The flange has parallel front and back faces which lie perpendicular to the axis of rotation and lead out to the very periphery of the flange. Threaded studs extend through the flange, projecting beyond its front face and through the brake rotor which is against the front face and the wheel which is against the brake rotor. When lug nuts, which are threaded over the studs, are tightened, the force imparted to the flange can distort the flange and the brake rotor which is against it producing runout or wobble in the friction surfaces of the rotor. This causes the brakes to operate less effectively and with greater wear, and may even produce so-called “brake judder”. Distortion of the hub flange may also occur when the flange resists heavy inertial loads incurred by negotiating turns at high speeds.

### SUMMARY OF THE INVENTION

The present invention resides in a hub assembly including a rotatable hub having a spindle that rotates in a bearing and a flange that is formed integral with the spindle and rotates with the spindle outside the bearing. The flange has a circumferential rib which imparts an added measure of stiffness to the flange.

### DESCRIPTION OF THE BEARING

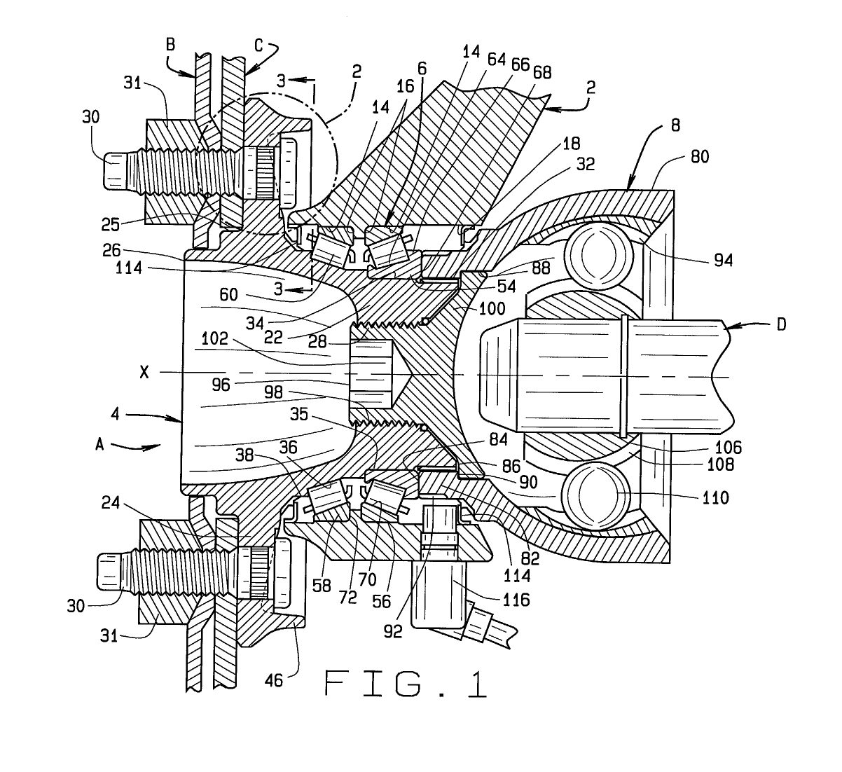

FIG. 1 is a longitudinal sectional view of a hub assembly constructed in accordance with and embodying the present invention;

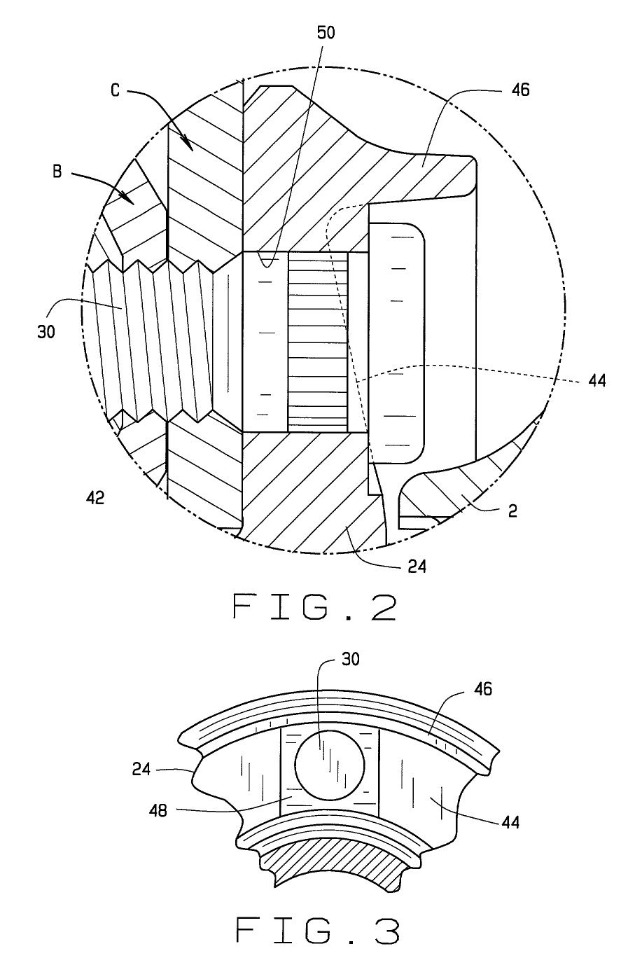

FIG. 2 is a fragmentary sectional view of the hub flange enlarged; and

FIG. 3 is a fragmentary sectional view taken along line 3-3 of FIG. 1.

### DETAILED DESCRIPTION

Referring now to the drawings (FIG. 1), a hub assembly A couples a road wheel B and brake rotor C for an automotive vehicle to the suspension system of the vehicle and may further couple the road wheel B to an axle shaft D forming part of the drive train for the vehicle. The suspension system includes (FIG. 1) a suspension member 2 that is designed to move generally vertically on the vehicle against the bias of a spring or torsion bar. Where the road wheel B that is coupled to the hub assembly A is at the front of the vehicle and thus steers the vehicle, the suspension member 2 typically takes the form of a steering knuckle. On the other hand, where the road wheel B is at the rear of the vehicle, the member 2 may take the form of a so-called “suspension upright”. In addition, the hub assembly A includes a hub 4 which rotates in the member 2 on a bearing 6 located between it and the member 2. Indeed, the bearing 6 enables the hub 4, brake rotor C, and the road wheel B to rotate about an axis X that is fixed in position with respect to the member 2. The hub assembly A may also include a CV (constant velocity) joint 8 which couples the hub 4 with the axle shaft D.

Considering the suspension member 2 first, it serves as a housing for the bearing 6 and to this end contains two bores 14 which receive the bearing 6. The bores 14 lead up to shoulders 16 at their inner ends and at their outer ends open into counterbores 18 which in turn open out of the member 2. The member 2 may be a separate housing attached to a knuckle or suspension upright.

The hub 4 includes a spindle 22 which extends into the member 2 and a flange 24 which is formed integral with spindle 22 as a single casting or forging and lies outside the member 2. In addition, the hub 4 has a rotor pilot 25 and wheel pilot 26 which are also formed integral with the flange 24 and project forwardly from it in the direction opposite that in which the spindle 22 projects. The hub 4 is hollow and at the inboard end of the spindle 22 is provided with a threaded bore 28. Finally, the hub 4 contains threaded studs 30 which project through the flange 24 and forwardly from it. Indeed, the studs 30 pass through the brake rotor C and road wheel B, beyond which they are engaged by lug nuts 31 for securing the wheel B and rotor C to the hub 4.

The spindle 22 at its inboard end has an external spline 32 which leads up to a cylindrical bearing seat 34 of slightly greater diameter. The bearing seat 34 includes the threaded bore 28 and lies with the inboard bore 14 of the suspension member 2. It leads up to a shoulder 35, beyond which the spindle 22 has a tapered raceway 36 that lies within the outboard bore 14 of the member 2. The small end of the raceway 36 is presented toward the bearing seat 34, its diameter being greater then the diameter of the seat 34, while its large end is located at a thrust rib 38 which leads out to the flange 24. The raceway 36 and thrust rib 38, while being integral with the spindle 22 of the hub 4, actually constitute part of the bearing 6.

The flange 24, into which the spindle 22 merges beyond the thrust rib 38, has (FIG. 2) a front face 42 which lies within a plane that is perpendicular to the axis X and a slightly conical back face 44. The front face 42 extends radially from the rotor pilot 25 out to essentially the periphery of the flange 24. Here the flange 24 has a rib 46 which projects rearwardly beyond the back face 44, it being continuous for the full circumference of the flange 24. The inclination of the conical back face 44 is such that the flange 24 is thicker where the back face 44 merges into spindle 22 than where the back face 44 merges into the circumferential rib 46. Unlike the rib 46, the conical back face 46 is not continuous, since it is interrupted by a several lands 48 (FIGS. 2 and 3) which we arranged at equal circumferential intervals and lie in a common plane that is also perpendicular to the axis X. Here the flange 24 is generally thicker than elsewhere along the back face 44. At the lands 48 the flange 24 is provided with bores 50 which extend axially through it and receive the threaded studs 30. Indeed, the studs 30 have heads which overlie the lands 48, and their shanks, in addition to being threaded beyond the front face 42 have splines which are lodged in the bore 50 to firmly secure the studs 30 in the flange 24. The flange 24, by reason of its circumferential rib 46, possesses a pie pan shape. The circumferential rib 46 imparts a good measure of rigidity to the flange 24, making it stiffer than flanges of conventional bearing assemblies.

The bearing 6 includes an inner race in the form the raceway 36 and thrust rib 38 on the spindle 22 and a cone 54 located around the bearing seat 34. It also includes an outer race in the form of an inboard cup 56 around the cone 54 and an outboard cone 58 around the raceway 36. Also, the bearing 6 has rolling elements in the form of tapered rollers 60 arranged in two rows, there being a separate row within each cup 56 and 58. Finally, the bearing 6 within each row of tapered rollers 60 includes a cage for maintaining the proper spacing between the rollers 60.

The cone 54 fits around the bearing seat 34 with an interference fit. It has a tapered raceway 64 which is presented outwardly away from the axis X and a thrust rib 66 at the large end of the raceway 64. The thrust rib 66 leads out to a back face 68 which is at the inner end of the spline 32 where it is squared off with respect to the axis X.

Each cup 56, 58 has a tapered raceway 70 that is presented inwardly toward the axis X and a back face 72 at the small end of the raceway 70, with its back face 72 likewise being squared off with respect to the axis X. The two cups 56, 58 fit into the bores 14 of the member 2 with an interference fit and with their back faces 72 against the shoulders 16 at the ends of the bore 14. The raceway 70 on the inboard cup 56 faces and is inclined in the same direction as the raceway 64 on the cone 54, whereas the raceway 70 on the outboard cup 58 faces and is inclined in the same direction as the raceway 36 on the spindle 22.

The inboard row of tapered rollers 60 lies between cone 54 and the inboard cup 56, where their tapered side faces contact the raceways 64 and 70 of the cone 54 and inboard cup 56, respectively, while their large end faces bear against the thrust rib 66 on the cone 54. The outboard row of tapered rollers 60 lies between the raceway 36 on the spindle 22 and the raceway 70 of the outboard cup 58, and the rollers 60 along their side faces contact those raceways 36 and 70. The large end faces of the rollers 70 of the outboard row bear against the thrust rib 38 on the spindle 22. The rollers 70 of each row are on apex, meaning that the conical envelopes of their side faces, as well as the conical envelopes for the raceways along which they roll, have their apices at a common point along the axis. Also, the inclination of the inboard raceways 64 and 70 is opposite that of the outboard raceways 36 and 70, so that the small ends of the rollers 60 in the inboard row are presented toward the small ends of the rollers 60 in the outboard row. This orientation enables the bearing 6 to accommodate thrust loads in both axial directions. Moreover, the bearing 6 is in a condition of preload so that no radial or axial clearances exist within it.

The CV joint 8 couples the axle shaft D to the hub 4, thus enabling the road wheel B and brake rotor C to rotate with the shaft D. To this end, the CV joint 8 includes an outer joint member 80 having a generally cylindrical end 82 which leads out to an end face 84 that is squared off with respect to the axis X. Internally, the cylindrical end 82 has a spline 86 which extends between the end face 84 and a counterbore 88, opening into the counterbore 88 at a shoulder 90. The cylindrical end 82 fits into the inboard counterbore 18 of the suspension member 2 and over the inboard end of the spindle 22 where its internal spline 86 engages the external spline 32 on the spindle 22. The end face 84 on the cylindrical end 82 bears against the back face 68 of cone 54, while the shoulder 90 lies slightly beyond the inboard end of the spindle 22. Externally, the cylindrical and end 82 has a target wheel 92 formed on it, and it constitutes a succession of disruptions arranged at equal circumferential intervals around the end 82. The target wheel 92 is located within the confines of the inboard counterbore 18 on the member 2 and typically includes a succession of axially directed grooves and teeth separating the grooves. Internally, the main body of the outer joint member 80 contains several arcuate grooves 94.

The outer joint member 80 of the CV joint 8 is secured to the hub 4 with a retainer 96 having a threaded plug 98 and a flange 100 directed outwardly from the plug 98. The thread on the plug 98 engages the threads of the threaded bore 28 in the spindle 22 of the hub 4, while the flange 100 lies within the outer joint member 80 behind the shoulder 90. The plug 98 contains a socket 102 that opens into the hollow interior of the spindle hub 4, and the socket 102 is configured to receive a wrench for turning the retainer 96. When the retainer 96 is turned down, it draws the flange 100 tightly against shoulder 90 in the outer joint member 80 of the CV joint 8. Thus, the retainer 96 captures the cylindrical end 82 of the member 80 and the cone 54 of the bearing 6 on the spindle 22 of the hub 4.

In addition to the outer joint member 80, the CV joint 8 has an inner joint member 106 provided with arcuate grooves 108 that open toward the grooves 94 in the member 80 and balls 110 that are located in the grooves 94 and 108, and couple the inner joint member 106 to the outer joint member 80. The axle shaft D is attached to the inner joint member 106.

The suspension member 2 within its counterbores 18 is fitted with seals 114. The seal 114 in the inboard counterbore 18 has an elastomeric element which bears against axially and radially directed surfaces on the outer joint member 80 of the CV joint 8, whereas the seal 114 in the outboard counterbore 18 has a elastomeric element which bears against axially and radially directed surfaces on the hub 4. Thus, the seals 114 isolate the bearing 6, retaining a lubricant within it and excluding contaminants from it.

Finally, the suspension member 2 contains a sensor 116 which is presented toward the target wheel 92 and monitors the rotation of the target wheel 92. The sensor 116 produces a signal which reflects the angular velocity of the target wheel 92 and of course the angular velocity of the hub 4 and wheel B as well.

In the operation of the vehicle on which the hub assembly A is installed, the hub 4 rotates in the suspension member 2: under torque transferred to it through the CV joint 8. The bearing 6 facilitates the rotation with minimal friction and a good measure of stability, owing to the preload in it. The road wheel B and brake rotor C, being coupled to the hub 4 at the flange 24, likewise rotate, and the road wheel B propels the vehicle over a road or other surface.

When the vehicle negotiates turns at high speeds, the road wheel experiences substantial inertial forces, and they are resisted by flange 24 on the hub 4 In spite of the inertial forces, the flange 4 does not experience any significant flexure owing to the presence of the circumferential rib 46 and the thickened inner region. As a consequence, the flange 24 rotates with reduced runout in its front face 42, and the brake rotor C, being against the front face 42, likewise rotates with reduced runout.

Also, the front face 42 of the flange 24 experiences less distortion when the lug nuts 31 are turned down tightly over the studs 30 to secure the road wheel B and brake rotor C against the flange 24. Again the circumferential rib 46 stiffens the flange 24 and reduces distortion of its front face 42 in the presence of the localized forces exerted by the studs 30.

The outer raceways 70 of the bearing 6 may be formed on a housing that is attached to or part of the suspension member 2, in which event the separate cups 56 and 58 are eliminated. The inner raceway 36 and its thrust rib 38 may be on a separate cone fitted to the spindle 22 of the hub 4 much like the cone 54. The bearing 6 may be an angular contact ball bearing instead of a tapered roller bearing, in which event the raceways, while being generally inclined to axis X, are arcuate, and the rolling elements are spherical.

Having thus described the invention, what is claimed and desired to be secured by Letters Patent is:

1. A hub assembly for coupling a road wheel to the suspension system of an automotive vehicle, said hub assembly comprising: a housing; a hub; and a bearing located between the housing and the hub for enabling the hub to rotate with minimal friction relative to the housing about an axis X; the hub including a spindle that extends into the housing and into the bearing, and a flange formed integral with the spindle and located outside the housing, the flange including a circumferentially directed rib located outwardly beyond the spindle.

2. A hub assembly according to claim 1 wherein the flange has a front face that is presented away from the housing and a back face that is presented toward the housing; and wherein the rib projects axially beyond the back face.

3. A hub assembly according to claim 1 wherein the circumferential rib is at the periphery of the flange.

4. A hub assembly according to claim 3 wherein the front face of the flange is perpendicular to the axis; wherein the back face is generally conical and oblique to the axis; and wherein the front and back faces is separated a greater distance at the spindle then at the circumferential rib.

5. A hub assembly according to claim 4 wherein the back face is interrupted with lands which lie perpendicular to the axis.

6. A hub assembly according to claim 5 wherein the hub further includes threaded studs extended through the flange at the lands.

7. A hub assembly according to claim 2 wherein the hub further includes threaded studs extended through the flange and projecting beyond the front face of the flange.

8. In combination with a road wheel and a brake rotor for an automotive vehicle, a hub assembly comprising: a hub having a spindle and a flange formed integral with and projecting outwardly from the spindle, the flange having a front face against which the road wheel and brake rotor are secured, and a back face, the flange does having a rib extending circumferentially and projecting beyond the back face; and a bearing located around the spindle for enabling the hub, wheel, and brake rotorto rotate about an axis.

9. The combination according to claim 8 wherein the back face is slightly conical and oblique to the axis, with the spacing between the front and back faces being greater at the spindle than at the circumferential rib.

10. The combination according to claim 9 wherein the back face is interrupted by lands which tie perpendicular to the axis.

11. The combination according to claim 10 wherein the front face is perpendicular to the axis.

12. The combination according to claim 10 wherein the hub further comprises threaded studs which extend axially through it at the lands and project beyond its front face.

13. The combination according to claim 8 and further comprising a housing surrounding the bearing.

14. The combination according to claim 13 wherein the bearing includes inboard raceways carried by the spindle and housing and being oblique to the axis and inclined in the same direction, inboard rolling elements arranged in a row between the inboard raceways, outboard raceways carried by the spindle and housing and also being oblique to the axis and inclined in the same direction, which direction the opposite direction in which the inboard raceways are inclined, and outboard rolling elements in a row between the outboard raceways.

15. The combination according to claim 14 wherein the bearing is in preload.
